(19) United States
(12) Patent Application Publication
(10) Pub. No.: US 2008/0143807 A1
(43) Pub. Date: Jun. 19, 2008

(54) MEDIA PRINTING AND FOLDING SYSTEM

(76) Inventors: Russell L. Bartley, Urbana, OH (US); Donald R. Allred, Springboro, OH (US); Gregory J. Sexton, Beavercreek, OH (US)

Correspondence Address: David A. Novais, Patent Legal Staff;Eastman Kodak Company, 343 State Street, Rochester, NY, 14650-2201, US

(21) Appl. No.: 11/609,965

(22) Filed: Dec. 13, 2006

(51) Int. Cl. B41J 2/01

(52) U.S. Cl. 347/104

(57) ABSTRACT

A system for printing and folding media including a plurality of detectable features located on the media with each of the plurality of detectable features having a predefined spacing relative to each other includes a print station for printing on the media; a sensor for detecting a spacing of the plurality of detectable features after the media has been printed; a media folder mechanism operable to fold the media after the media has been printed; and a controller operable to adjust an action of the media folder mechanism based on a comparison of the spacing of the plurality of detectable features after the media has been printed with the predefined spacing of the plurality of detectable features.

### FIELD OF THE INVENTION

This invention relates generally to the field of digitally controlled printing systems, and in particular to a system and method for printing and folding media.

### BACKGROUND OF THE INVENTION

Referring to FIG. 1, a prior art system for creating documents on tractor-feed fanfold media is shown. A printing and folding system 1 accepts media in the form of a media supply roll 2. Media 3 from supply roll 2 is drawn past first and second print stations 4, 6 by a pull station 8. A turn station 5 can be used to turn media 3 over between first and second print stations 4, 6 so that both sides of media 3 can be printed. Print stations 4, 6 are typically offset presses and can include dryers to fix ink printed on media 3. A punch and perforation station 9 creates tractor feed holes along sides of media 3 and perforation lines between pages of media 3. A folder station 10 folds media 3 along the perforation lines in what is commonly referred to as a fanfold manner.

Pull station 8, punch and perforation station 9, and folder station 10 are driven by a common drive motor 11 via a common drive shaft 12. As such, the action of folder station 10 is synchronized with the perforation lines in media 3 so that media 3 folds at the perforation lines as media 3 is deposited in a media receiving device 29.

Typically, printing and folding system 1 works quite well when media 3 is printed using an offset printing stations 4, 6. While media 3 may stretch as it passes through printing and folding system 1, the stretch is very consistent and can be controlled by tension on media 3 as it passes through printing and folding system 1. Accordingly, registration of perforation lines, media folds, and printed image(s) relative to each other can be easily maintained during printing and folding of media 3.

However, registration problems are encountered when first and second printing stations 4, 6 are high speed inkjet printing stations using water-based marking fluids, for example, inks. Media 3 expands when it is printed with water-based inks. As such, the printed document length can vary depending on several factors including media tension as the media travels through system 1, the amount of ink applied to media 3, and the ink dryer power of dryers included in first and second printing stations 4, 6.

While the variations in document length aren't large for a single document, for example, on the order of 0.2%, document length variations accumulate as more documents are printed making registration of the perforation lines, media folds, and printed image(s) relative to each other very difficult. A printed image(s) can include text and/or graphics.

For example, consider a situation where the intended page length is 25 cm long, so that the top or beginning of printed pages is spaced apart by 25 cm, and perforation lines and fold lines are also spaced apart by 25 cm. If media 3 expands or stretches by 0.2% during the printing process by the time the printed pages arrive at the punch and perforation station 9, the printed pages are 25.05 cm in length. As the punch and perforation station 9 and the folder station 10 are setup for 25 cm page lengths, the printed images begin to drift relative to the perforation lines 22. This drift error accumulates so that, for example, it only takes 100 documents to cause the printed image to be misregistered from the perforation lines by 5 cm. As high speed inkjet printing stations are commonly employed to print printed images with variable content, the media expansion isn't consistent like it would be with an offset printing station. As a result, one can't compensate by adjusting paper tension as one would do with an offset printing station. This problem is illustrated in FIGS. 2A and 2B.

Referring to FIGS. 2A and 2B, tractor feed holes 21 have been formed along each side of media 3 that includes printed images 44. In FIG. 2A, media 3 has also been perforated creating perforation lines 22 spaced apart from each other by a distance D1. As shown in FIG. 2B, the dimensions of media 3 have changed such that printed images 44 are spaced apart from each other by a distance D2. However, perforation lines 22 remain spaced apart from each other by distance D1 which causes misregistration of printed images 44 with perforation lines 22.

Also consider a situation in which perforations are created at a 25 cm spacing relative to each other. If media 3 expands or stretches by 0.2% during the printing process, perforation lines in media 3 would be at 25.05 cm spacing relative to each other. If folding station 10 were to make folds in media 3 at the original 25 cm perforation line spacing, it would only take 100 documents before the folds in media 3 are offset from the perforation lines in media 3 by 5 cm. This problem is illustrated in FIGS. 2C and 2D.

Referring to FIGS. 2C and 2D, tractor feed holes 21 have been formed along each side of media 3. Media 3 has also been perforated creating perforation lines 22 spaced apart from each other by a distance D1. Folder station 10 (not shown in FIGS. 2C and 2D) operates to fold media 3 along fold 24. In FIG. 2C, each media fold 24 occurs in a location of media 3 that also includes perforation line 22. As shown in FIG. 2D, media 3 has expanded or stretched during the printing process such that perforation lines 22 on media 3 are now located relative to each other at a spacing D2 that is greater than spacing D1. However, folder station 10 is still creating folds 24 at spacing D1. As such, fold 24 is caused to move or drift farther and farther away from perforation line 22 as more media accumulates in fanfold stack 23.

Accordingly, there is a need to be able to fold media that compensates for changes in media dimensions that occur during printing.

### SUMMARY OF THE INVENTION

According to a feature of the present invention, a method of printing and folding media includes providing a media including a plurality of detectable features located on the media, each of the plurality of detectable features having a predefined spacing relative to each other; printing on the media; measuring a spacing of the plurality of detectable features after printing on the media; comparing the spacing of the plurality of detectable features after printing on the media with the predefined spacing of the plurality of detectable features; and folding the media using a media folding mechanism by adjusting an action of a media folder mechanism based on the comparison of the spacing of the plurality of detectable features after printing on the media with the predefined spacing of the plurality of detectable features.

According to another feature of the present invention, a system for printing and folding media including a plurality of detectable features located on the media with each of the plurality of detectable features having a predefined spacing relative to each other includes a print station for printing on the media; a sensor for detecting a spacing of the plurality of detectable features after the media has been printed; a media folder mechanism operable to fold the media after the media has been printed; and a controller operable to adjust an action of the media folder mechanism based on a comparison of the spacing of the plurality of detectable features after the media has been printed with the predefined spacing of the plurality of detectable features.

### BRIEF DESCRIPTION OF THE DRAWINGS

In the detailed description of the preferred embodiments of the invention presented below, reference is made to the accompanying drawings, in which:

FIG. 1 is a simplified schematic diagram illustrating a prior art system for printing and folding media;

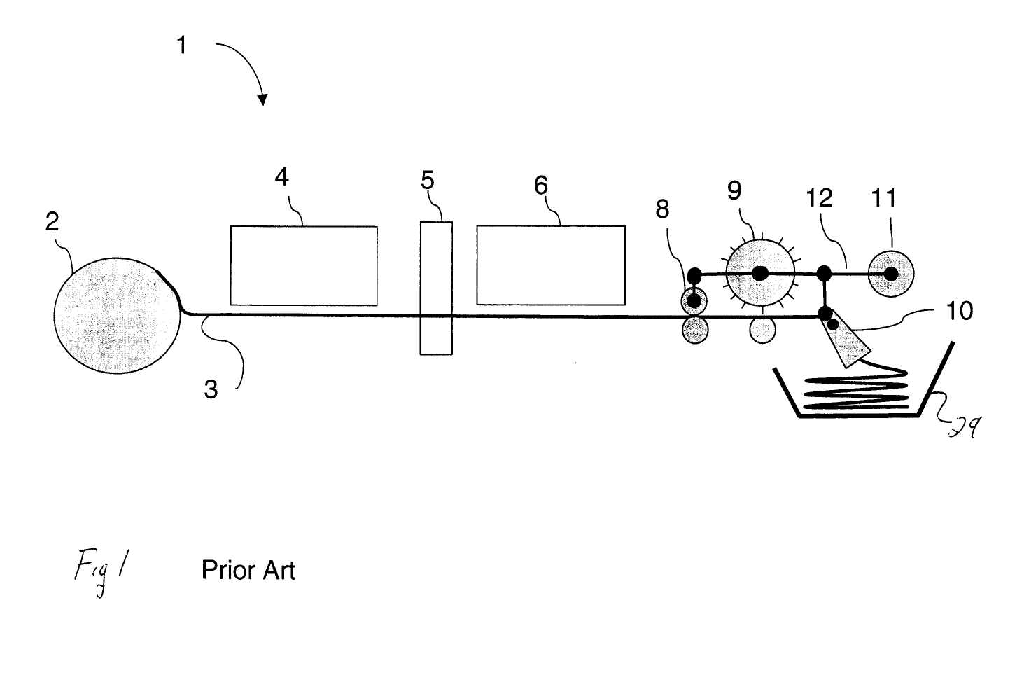

FIGS. 2A, 2B, 2C, and 2D are simplified schematic diagrams illustrating the problems solved by the present invention;

FIG. 3 is a simplified schematic diagram of one exemplary embodiment made according to the present invention;

FIGS. 4A and 4B are simplified schematic diagrams illustrating sensor and encoder output signals associated with changes in media dimensions that occur during printing;

FIG. 5 is a simplified block diagram illustrating a method according to the present invention; and

FIG. 6 is a simplified schematic diagram illustrating one solution to the problems solved by the present invention.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

A system for printing and folding media made in accordance with the present invention is suitable for use with media that includes a plurality of detectable features located on the media with each of the plurality of detectable features having a predefined spacing relative to each other. Examples of the plurality of detectable features located on the media include, but are not limited to, holes in the media, printed marks on the media, an embossed feature on the media, perforation lines on the media, and notches on an edge of the media.

The system includes a print station, for example, an inkjet print station, for printing, for example, a water based marking fluid (for example, ink) on the media. A sensor is used to detect a spacing of the plurality of detectable features after the media has been printed. A media folder station located downstream from the print station includes a mechanism(s) operable to fold the media. The media folder station is in electrical communication with a controller that is operable to adjust an action of the media folder mechanism based on a comparison of the spacing of the plurality of detectable features after the media has been printed with the predefined spacing of the plurality of detectable features.

The plurality of detectable features located on the media can be present on the media prior to the media being fed into the system. Alternatively, the system of the present invention can include a station located upstream from the print station that includes a mechanism that is operable to create the plurality of detectable features on the media.

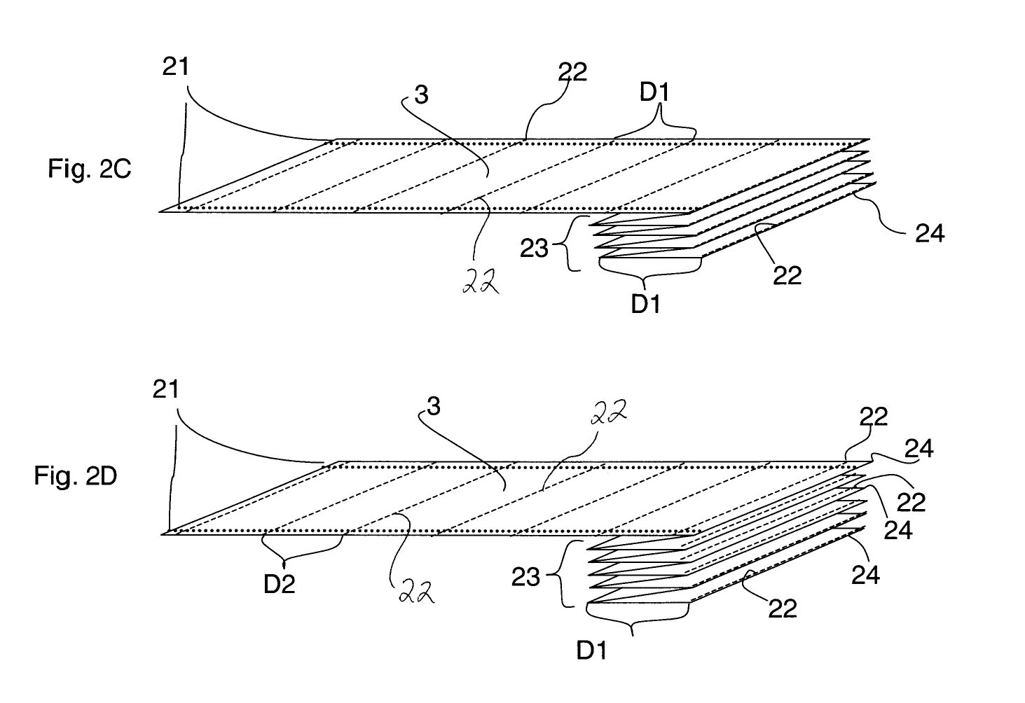

Example embodiments of the present invention will now be described with reference to FIGS. 3-6.

Referring to FIG. 3, an example embodiment of printing and folding system 1 made in accordance with the present invention is shown. Printing system 1 accepts media 3 in the form of media supply rolls 2. Media 3 passes through a punch and perforation station 9 before being printed at a first inkjet print station 14.

Punch and perforation station 9 includes a conventional mechanism(s) that is operable to form holes 21 and perforation lines 22. For example, punch and perforation station 9 can include a GSS Perforation Module and a GSS Punch Module, both commercially available for GSS Printing Equipment, Springboro, Ohio. Holes 21 (and perforation lines 22) have a predefined spacing relative to each other after formation. Optionally, a media web cleaning station 13 positioned before first inkjet print station 14 and after punch and perforation station 7 can be included to remove media debris that is created during punching and perforating of media 3 and can adversely affect inkjet reliability.

A first encoder 15 and a first cue sensor 16 are located in the area of first print station 14. Signals from first encoder 15 and first cue sensor 16 are used by an inkjet print station controller 30 to register the top or beginning of each document. Encoder 15 can be coupled to a media supply roller (not shown) to track media motion through first print station 14 such that each subsequent encoder output signal or pulse indicates that media 3 has moved a defined distance past encoder 15. Cue sensor 16 detects the top or beginning of a document page (and perforation lines 22) by being operable to detect feed holes 21, or other marks applied to media 3, that are synchronized with the perforation lines. Sensor 16 can be, for example, an optical sensor, a capacitive sensor, a magnetic sensor, an ultrasonic sensor, or an air flow sensor.

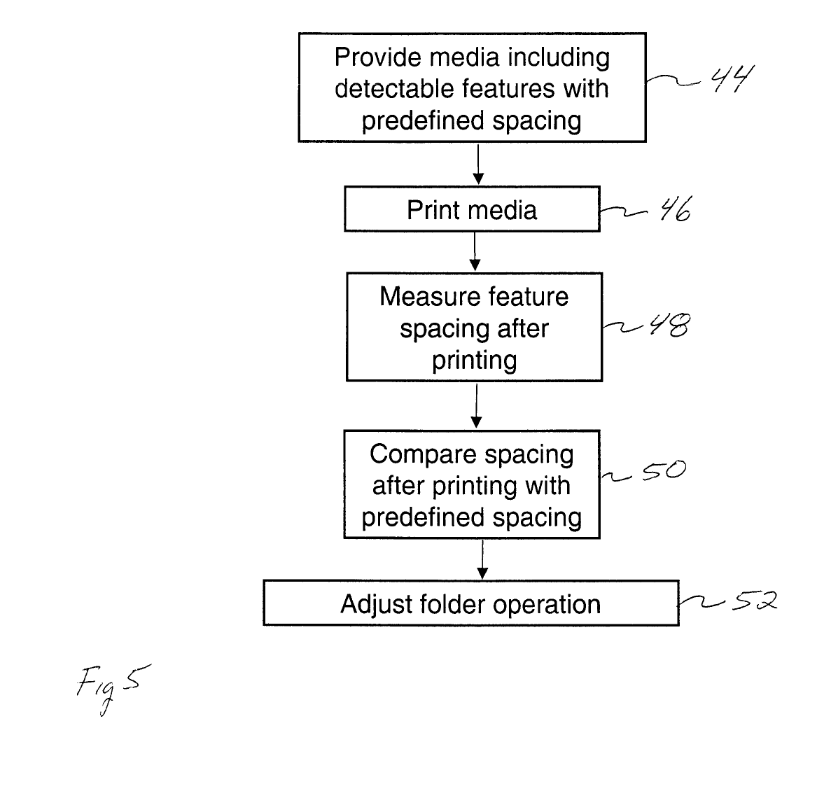

The location (upstream from print station 14) of punch and perforation station 9 overcomes the problem of misregistration of printed images 44 and perforation lines 22. This is because perforation lines 22 are created prior to dimensional changes in media 3 caused by, for example, printing and/or drying media 3. As shown in FIG. 6, printed images are spaced apart from each other by a spacing D2. Perforation lines 22 are also spaced apart from each other by a spacing D2. As such, printed images 44 are registered to perforation lines 22 and tractor feed holes 21.

Referring back to FIG. 3, optionally, system 1 can include a turn station 5 that inverts media 3 so that a second inkjet print station 17 can print on a second or back side of media 3. Signals from a second encoder 18 and a second cue sensor 19 are used by inkjet print station controller 30 to register the start of each document printed by second print station 17 with perforation lines 21 so that printed data, for example, text and/or images, on both sides of media 3 can be properly registered with perforated media 3. Either or both of print stations 14, 17 can also include a dryer for drying marking fluid, for example, ink printed on media 3. Media 3 from supply roll 2 is drawn past first and second print stations 4, 6 by a pull station 8 that includes one or more driven rollers.

System 1 includes a folder station control system 20 located downstream from pull station 8. Control system 20 is operable to control and adjust action, for example, speed, movement, and/or travel length of folder station 10. Folder station 10 includes a conventional mechanism(s) that fold media 3. For example, folder station 10 can be a Fordyce Folder Model VS-40, commercially available from G Fordyce Co., Hillsboro, Ohio.

Control system 20 includes a sensor 25 that detects feed holes 21 located along at least one edge of media 3 and an encoder, for example, a third encoder 26. Alternatively, the encoder associated with another print station, for example, the last print station (second encoder 18 in the example embodiment shown in FIG. 3), can be used. Again, each pulse from encoder 26 or 18 indicates that media 3 has moved a defined distance past encoder 26 or 18. Control system 20 also includes a controller 32.

Using signals from sensor 25 and third encoder 26, control system 20 measures the distance between feed holes 21 by counting the number of encoder output signals or pulses between feed holes 21. This distance can be measured between successive feed holes 21 or by counting encoder pulses for a pre-selected number of feed holes “n” detected by sensor 25.

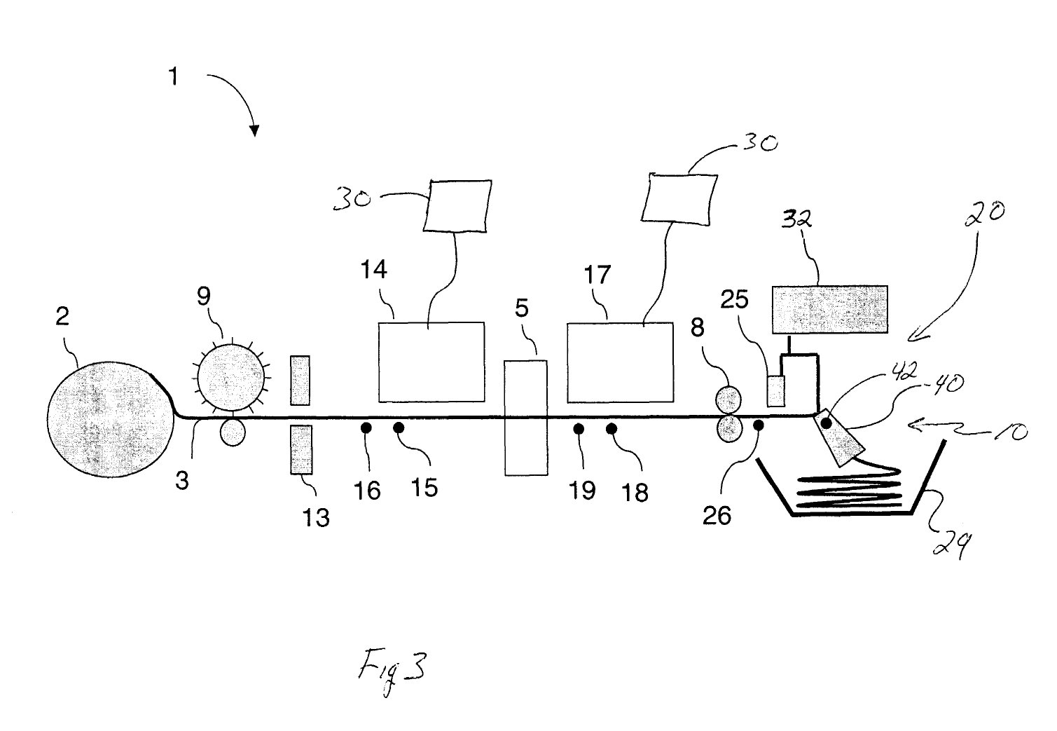

Referring to FIGS. 4A and 4B, simplified schematic diagrams illustrating sensor and encoder output signals associated with changes in media dimensions that occur during printing are shown. Media 3 can stretch due to tension on media 3 associated with being pulled through system 1 or expand due to moisture added by the printing process. When this occurs, the output signals, pulses, or count of encoder 26 for “n” feed holes detected by sensor 25 measures a change in length of media 3. In FIGS. 4A and 4B, arrows 34 correspond to a time in which perforation lines 22 pass sensor 25. Trace 36 illustrates output signals or pulses produced by sensor 25 as feed holes 21 pass sensor 25. Trace 38 illustrates output signals or pulses from third encoder 26.

In FIG. 4A, media 3 has not stretched or expanded. However, in FIG. 4B, media 3 has stretched or expanded. As such, the distance between perforation lines 22 has changed, shown in FIG. 4B by arrows 34 being shifted to the right of the figure at times n+d and 2(n+d). Since perforation line 22 spacing and the spacing between feed holes 21 change at the same rate, sensor pulses 27 remain registered with perforation lines 22. Accordingly, the number of sensor pulses 27 between perforation lines 22 in FIGS. 4A and 4B are equivalent. However, the number of encoder pulses 28 between perforation lines 22 for “n” holes to pass sensor 25 is different in FIGS. 4A and 4B. In FIG. 4B, the number of encoder pulses 28 between perforation lines 22 for “n” holes to pass sensor 25 is greater than the number of encoder pulses 28 shown in FIG. 4A because the distance between perforation lines 22 has changed due to the stretching and/or expanding of media 3.

Controller 32 compares the non-stretched/non-expanded number of encoder pulses 28 for sensor pulses 27 of “n” holes with the stretched/expanded number of encoder pulses 28 for sensor pulses 27 of “n” holes. The non-stretched/non-expanded number of encoder pulses 28 for sensor pulses 27 of “n” holes can be calculated using media dimensions, system operating speeds, number of holes, and the predefined spacing of the holes. Alternatively, the non-stretched/non-expanded number of encoder pulses 28 for sensor pulses 27 of “n” holes can be calculated during initial set up of the system by running media through the system without printing on the media (which changes the dimensions of the media).

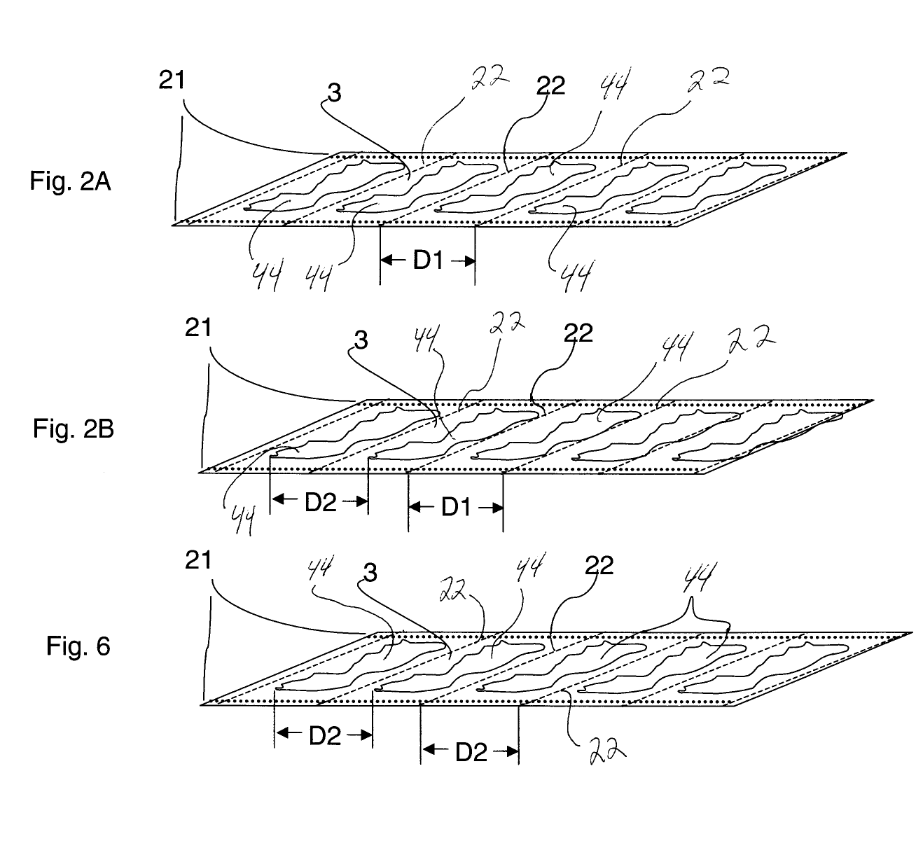

Using this comparison of encoder pulses 28 for sensor pulses 27 of “n” holes, controller 32 of control system 20 can adjust the action of an output of folder station 10 to change the spacing of folds to compensate for media stretch. For example, the travel length of the output of the folder station 10 and/or the speed of the output of the folder station 10 can be increased or decreased by controller 32. As a result, media folds 24 remain registered with perforation lines 22 of media 3 as media 3 is folded into media receiving device 29 (as shown in FIG. 2C). The output of folder station 10 can be a chute 40 and include any number of associated sensors, motors, etc. (shown generally using 42) to indicate initial speed, location, etc. and affect adjustment of the action.

The specific action of folder station that is adjusted by control system 20 is typically dependent on the specific type of folder station 10 incorporated into printing system 1. For example, the operation speed of folder station 10 can be increased or decreased in order to ensure that media folds per minute correspond to the number of perforations per minute. Alternatively, the travel stroke of folder station 10 can be increased or decreased in order to maintain the same condition.

Typically, to initiate the operation of the example embodiment of folder control system 20 described above, the number of feed holes 21 between perforation lines 22 is input into controller 32. Folder station 10 is initially adjusted to match the intended media fold 24 spacing and initially registered to a perforation line 22 of media 3.

Due to media expansion between second encoder 18 and third encoder 26, the number of encoder pulses 28 from third encoder 26 for “n” feed holes 21 to pass sensor 25 may differ from the number of encoder pulses 28 for “n” feed holes 21 to pass the encoder associated with the last print station (in this example, second encoder 18). However, it has been found that there is sufficient correlation between the counts from second encoder 18 and third encoder 26 that proper registration of media folds 24 to perforation lines 22 can be achieved using the encoder associated with the last print station, second encoder 18, as the input to controller 32 of control system 20.

Control system 20 is effective in maintaining registration between folds 24 and perforation lines 22 regardless of whether a punch and perforation station 9 is included with system 1. Accordingly, the detectable features of media 3, for example, holes, can be punched and perforated in an in-line process, for example, just before the inkjet printing station as outlined above. Alternatively, media 3 can be pre-punched and perforated in an off-line process, for example, on another processing line.

Folder control system 20 has been described in terms of measuring the spacing between media feed holes, however, the invention is not limited to the measuring the spacing between feed holes. In practice, action of folder station 10 can be controlled based on the measured spacing between perforation lines or the measured spacing between any other detectable feature, for example, notches, printed marks, etc., that are applied to the media at substantially the same time as the perforation lines are created.

Application of the detectable features at substantially the same time as the creation of the perforation line means that the media undergoes little or no dimensional changes between creation of the detectable features and the creation of the perforation lines. The creation of the detectable features can precede, be concurrent with, or follow the creation of the perforation lines and still fall within the scope of being created at substantially the same time.

Subsequently the media is printed on using an inkjet printer, allowing the media to change dimensions. The distance between detectable marks is measured. Finally the action of the folder station is adjusted to account for the changes in the measured dimension.

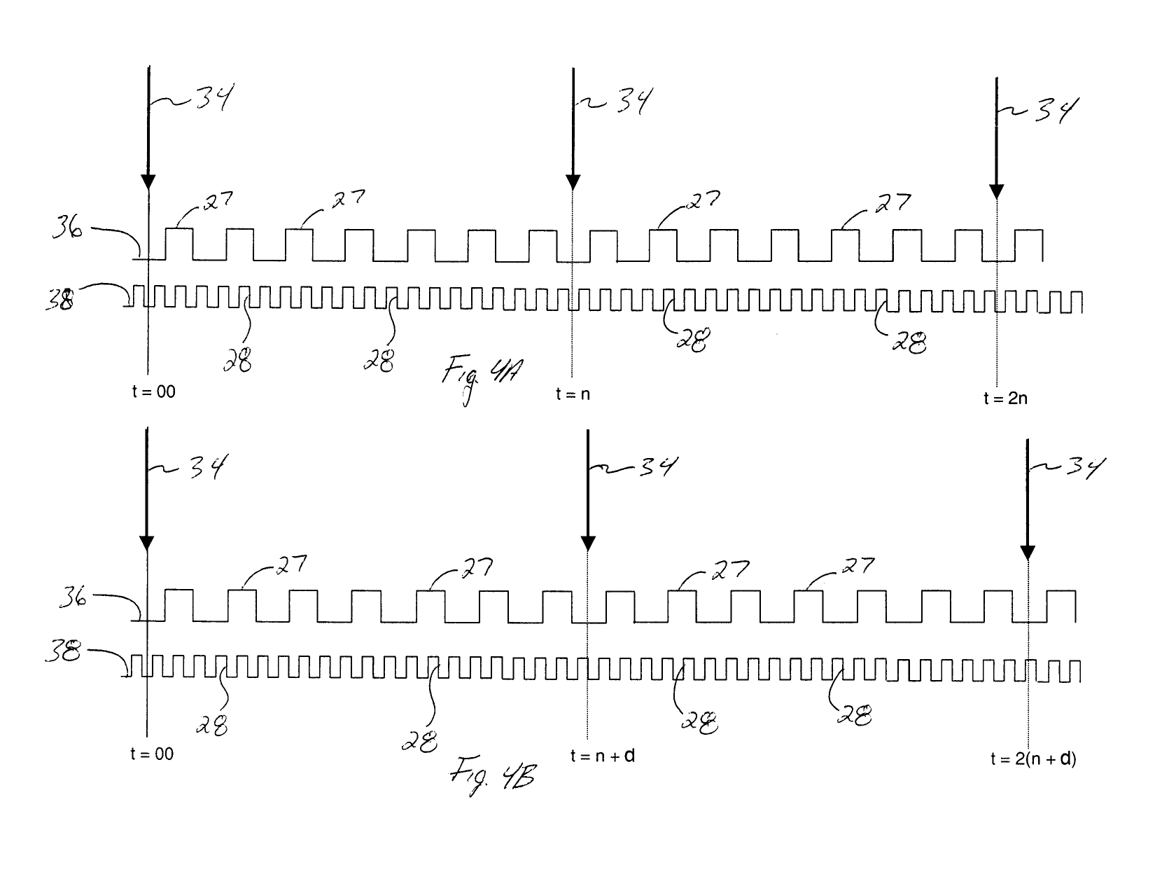

Referring to FIG. 5, a method of printing and folding according to the present invention is shown. Media is provided to the system 1 (step 44). The media includes a plurality of detectable features located on the media with each of the plurality of detectable features having a predefined spacing relative to each other. The plurality of detectable features located on the media can be created using an in-line process or an off-line process.

The media is printed (step 46). Printing can be accomplished using an inkjet printing station or system that prints a water based marking fluid, for example, ink.

The spacing of the plurality of detectable features is measured after the media has been printed (step 48). This can be accomplished, for example, by counting output signals of an encoder for a number “n” of detectable features. The number “n” of detectable features can be counted using a sensor. In some embodiments of the methods, the media can be printed on at least one additional time after the spacing of the plurality of detectable features is measured.

The spacing of the plurality of detectable features after printing on the media is compared with the predefined spacing of the plurality of detectable features (step 50). This can be accomplished, for example, by comparing the number of output signals from the encoder to a calculated number of encoder output signals that is based on the predefined spacing of the plurality of detectable features.

The media is folded using a media folding mechanism by adjusting an action of a media folder mechanism, if necessary, based on the comparison of the spacing of the plurality of detectable features after printing on the media with the predefined spacing of the plurality of detectable features (step 52). Adjusting the action of the media folder mechanism can include, for example, adjusting a speed of an output of the media folder mechanism and/or adjusting a travel length of an output of the media folder mechanism.

The invention has been described in detail with particular reference to certain preferred embodiments thereof, but it will be understood that variations and modifications can be effected within the scope of the invention.

### PARTS LIST

1 Printing system
2 Media supply roll
3 Media
4 First print station
5 Turn station
6 Second print station
8 Pull station
9 Punch and perforating station
10 Folder station
11 Drive motor
12 Drive shaft
13 Web cleaner
14 First inkjet print station
15 First encoder
16 First cue sensor
17 Second inkjet print station
18 Second encoder
19 Second cue sensor
20 Control System
21 Tractor feed holes
22 Perforation line
23 Fanfold stack
24 Fold
25 Sensor
26 Third encoder
27 Sensor pulses
28 Encoder pulses
29 Media receiving device
30 Controller
32 Controller
34 Arrows
36 Trace
38 Trace
40 Chute
42 Sensors, motors, etc.
44 Printed images
D1 Spacing
D2 Spacing

1. A method of printing and folding media comprising:
providing a media including a plurality of detectable features located on the media, each of the plurality of detectable features having a predefined spacing relative to each other;
printing on the media;
measuring a spacing of the plurality of detectable features after printing on the media;
comparing the spacing of the plurality of detectable features after printing on the media with the predefined spacing of the plurality of detectable features; and
folding the media using a media folding mechanism by adjusting an action of a media folder mechanism based on the comparison of the spacing of the plurality of detectable features after printing on the media with the predefined spacing of the plurality of detectable features.

2. The method of claim 1, wherein printing on the media includes printing on the media using an inkjet printing operation.

3. The method of claim 1, wherein printing on the media includes printing on the media using a water based marking fluid.

4. The method of claim 1, wherein the plurality of detectable features include one of holes in the media, printed marks on the media, an embossed feature on the media, perforation lines on the media, and notches on an edge of the media.

5. The method of claim 1, wherein measuring the spacing of the plurality of detectable features after printing on the media includes counting output signals of an encoder.

6. The method of claim 5, wherein comparing the spacing of the plurality of detectable features after printing on the media with the predefined spacing of the plurality of detectable features includes comparing the number of output signals from the encoder to a calculated number of encoder output signals based on the predefined spacing of the plurality of detectable features.

7. The method of claim 1, wherein measuring the spacing of the plurality of detectable features after printing on the media includes measuring the spacing between “n” detectable features using sensor.

8. The method of claim 1, wherein adjusting the action of the media folder mechanism based on the comparison of the spacing of the plurality of detectable features after printing on the media with the predefined spacing of the plurality of detectable features includes adjusting a speed of an output of the media folder mechanism.

9. The method of claim 8, wherein the output of the media folder mechanism is a chute.

10. The method of claim 1, wherein adjusting the action of the media folder mechanism based on the comparison of the spacing of the plurality of detectable features after printing on the media with the predefined spacing of the plurality of detectable features includes adjusting a travel length of an output of the media folder mechanism.

11. The method of claim 1, wherein measuring the spacing of the plurality of detectable features after printing on the media includes using one of an optical sensor, a capacitive sensor, a magnetic sensor, and an air flow sensor.

12. The method of claim 1, further comprising:
printing on the media at least one additional time after measuring the spacing of the plurality of detectable features after printing on the media.

13. The method of claim 1, wherein providing the media including a plurality of detectable features located on the media includes creating the detectable features in an offline process.

14. The method of claim 1, wherein providing the media including a plurality of detectable features located on the media includes creating the detectable features in an inline process.

15. The method of claim 1, wherein printing on the media includes printing on the media and drying the media.

16. A system for printing and folding media including a plurality of detectable features located on the media, each of the plurality of detectable features having a predefined spacing relative to each other, the system comprising:
a print station for printing on the media;
a sensor for detecting a spacing of the plurality of detectable features after the media has been printed;
a media folder mechanism operable to fold the media after the media has been printed; and
a controller operable to adjust an action of the media folder mechanism based on a comparison of the spacing of the plurality of detectable features after the media has been printed with the predefined spacing of the plurality of detectable features.

17. The system of claim 16, wherein the print station is an inkjet print station.

18. The system of claim 16, further comprising:
a mechanism operable to create the plurality of detectable features on the media, the mechanism being located upstream from the print station.
